(19) United States
(12) Patent Application Publication
(10) Pub. No.: US 2022/0013253 A1
(43) Pub. Date: Jan. 13, 2022

(54) Cable with improved corrosion resistance

(71) Applicant: NEXANS, Courbevoie (FR)

(72) Inventors: Basil SALAME, PARIS (FR); Adrien CHARMETANT, MIRIBEL (FR); Thomas HAEHNER, VERRIERES LE BUISSON (FR)

(21) Appl. No.: 17/324,946

(22) Filed: May 19, 2021

(30) Foreign Application Priority Data
May 20, 2020 (FR) 20 05377

(51) Int. Cl. H01B 7/28; H01B 7/29; H01B 13/22; H01B 3/44

(52) U.S. Cl. CPC H01B 7/2806; H01B 7/292; H02G 3/0412; H01B 3/445; H01B 13/222

(57) ABSTRACT

An electric cable is providing having at least one elongated electrically conducting element containing a plurality of electrically conducting strands and at least one fluorinated polymer layer surrounding said elongated electrically conducting element, said cable further comprising a metallic layer comprising nickel interposed between the elongated electrically conducting element and the fluorinated polymer layer, and a method of manufacturing said cable.

### RELATED APPLICATION

This application claims the benefit of French Patent Application No. 20 05377, filed on May 20, 2020, the entirety of which is incorporated be reference.

### FIELD OF THE INVENTION

The present invention relates to an electric cable comprising at least one elongated electrically conducting element containing a plurality of electrically conducting strands and at least one fluorinated polymer layer surrounding said elongated electrically conducting element, said cable further comprising a metallic layer comprising nickel interposed between the elongated electrically conducting element and the fluorinated polymer layer, and a method of manufacturing said cable.

The invention applies typically but not exclusively to electric cables intended for power transmission, in particular to low-voltage power cables (for example below 6 kV) or very low voltage data transmission cables (for example below 50 V for alternating current or 120 V for direct current), medium-voltage (in particular from 6 to 45-60 kV) or high-voltage (in particular above 60 kV, and possibly up to 400 kV), whether direct-current or alternating-current, in the fields of overhead, underwater, or terrestrial electric power transmission, or in aeronautics. The invention applies in particular to electric cables used in the field of aeronautics, for example on board aircraft.

### DESCRIPTION OF RELATED ART

This type of electric cable must satisfy a large number of criteria necessary for its use in aeronautics, especially when it is subject to high voltages, of the order of 230 V, and for cables located in non-pressurized zones.

This relatively high voltage, combined with the stresses associated with aeronautics, such as humidity, high temperature and low pressure, may cause corrosion of electronic equipment, such as electric cables.

Other criteria may also be taken into account, such as the weight and the diameter of said cable, which must not be excessive, and the markability of said cable to allow it to be identified when necessary.

In the field of aeronautics, the use of a cable is known comprising a plurality of electrically conducting metallic strands and at least one fluorinated polymer layer surrounding the plurality of electrically conducting strands. Now, the polymers generally used in the fluorinated polymer layer such as polytetrafluoroethylene (PTFE), and in particular the products resulting from their decomposition over time, are very corrosive for the electrically conducting metallic strands, in particular on account of their fluorine content as well as the high temperatures required for their manufacture. It is therefore known to coat each of the strands with a metallic layer of silver.

In particular, the American patent application U.S. Pat. No. 3,397,046 describes a cable comprising an electrically conducting element, a layer of silver surrounding said electrically conducting element, a layer of a crosslinked polyorganosiloxane derived from a monomethyl silicone fluid surrounding said layer of silver, and a fluorinated polymer layer surrounding said layer of a crosslinked polyorganosiloxane. However, the corrosion resistance of a cable of this kind is not optimized. In particular, said corrosion resistance is dependent on the production of a uniform, defect-free layer of silver, on each of the electrically conducting strands, and an environment that is not too humid (humidity below 50%). Moreover, the cable in U.S. Pat. No. 3,397,046 requires the use of an additional polymer layer, which is not without consequence for the total weight of the cable obtained. Finally, the use of silver as the metal increases the cost of production of the cable.

### OBJECTS AND SUMMARY

The aim of the present invention is consequently to overcome the drawbacks of the techniques of the prior art and in particular to supply an electric cable having improved corrosion resistance, while guaranteeing a low cost of production and a weight that is as low as possible, especially when the cable is intended for the field of aeronautics and in flight is subject to high temperatures (around 150° C.) and low pressures (about 150 mbar).

This aim is achieved by the invention that will be described hereunder.

The first aim of the invention is an electric cable comprising at least one elongated electrically conducting element containing a plurality of electrically conducting strands, and at least one fluorinated polymer layer surrounding said elongated electrically conducting element, characterized in that said cable further comprises a metallic layer comprising nickel interposed between the elongated electrically conducting element and the fluorinated polymer layer, said metallic layer comprising nickel surrounding the plurality of electrically conducting strands.

Thus, owing to this metallic layer comprising nickel, in particular surrounding the plurality of electrically conducting strands, a cable is obtained that has improved corrosion resistance, while guaranteeing a low cost of production and a weight as low as possible.

### Electrically Conducting Element

The elongated electrically conducting element comprises a plurality of electrically conducting strands. The elongated electrically conducting element represents a stranded conducting core.

According to one embodiment of the invention, the elongated electrically conducting element comprises a central electrically conducting strand, at least one first layer of electrically conducting strands surrounding said central electrically conducting strand, and preferably at least one second layer of electrically conducting strands surrounding said first layer of electrically conducting strands. The central electrically conducting strand is thus positioned at the centre of the elongated electrically conducting element.

The elongated electrically conducting element preferably comprises at least two layers of electrically conducting strands.

The elongated electrically conducting element may further comprise one or more additional layers of electrically conducting strands. Thus, the electrically conducting strands are distributed in the first and second layers, and in the additional layer or layers of electrically conducting strands.

The elongated electrically conducting element may be positioned at the centre of the cable (i.e. central position). The elongated electrically conducting element is consequently a central elongated electrically conducting element.

An electrically conducting strand preferably has a diameter in the range from about 0.5 mm to 5 mm, and more preferably from about 1 mm to 3 mm.

The electrically conducting strands each have a diameter (or respectively a section) that complies with standard EN2083.

An electrically conducting strand may have a section in the range from about 0.25 mm² to 110 mm², and preferably from about 9 mm² to 100 mm².

The electrically conducting strands are preferably of circular or roughly circular (e.g. oval) section.

The elongated electrically conducting element preferably comprises uninsulated electrically conducting strands.

In the invention, the expression “uninsulated strands” or “bare strands” signifies that each of said strands is without an electrically insulating layer, in particular each of said strands is without an electrically insulating layer surrounding said strand, in particular an electrically insulating layer based on polymer(s) and/or ceramic(s).

Advantageously, all the electrically conducting strands of the elongated electrically conducting element are uninsulated strands.

An electrically conducting strand of the elongated electrically conducting element preferably has at least one direct physical contact surface with another strand of the elongated electrically conducting element that is adjacent to it.

Each of the electrically conducting strands forming the elongated electrically conducting element of the cable of the invention may comprise one or more electrically conducting wires, and preferably several electrically conducting wires. It is then called a multiwire electrically conducting strand. This thus allows the multiple-strand electrically conducting element to be made flexible.

Each of the electrically conducting wires of a strand preferably has a diameter in the range from about 0.1 mm to 0.5 mm, and more preferably from about 0.2 mm to 0.45 mm.

The electrically conducting wire may have a section in the range from about 0.007 mm² to 10 mm², and preferably from about 0.03 mm² to 5 mm².

The elongated electrically conducting element preferably comprises stranded or twisted electrically conducting strands. This makes it possible to obtain a concentric assembly for preserving cylindrical shape and flexibility.

Advantageously, all the electrically conducting strands of the elongated electrically conducting element are assembled by stranding operations, in particular to form a strand or a bunch. They are then called stranded or bunched conductors.

The formation of a stranded conductor is also referred to as “stranded wires”, and the formation of a bunched conductor is also referred to as “bunched wires”. Bunching makes it possible to twist individual strands or wires together in the same direction, said individual strands or wires not having a specific configuration or a particular geometric arrangement relative to one another. The strands or wires therefore undergo a twisting process, said strands initially being arranged in bundles. In this embodiment, the mechanical properties are optimized, in particular in terms of flexibility.

The elongated electrically conducting element is preferably in the form of a bunch. This makes it possible to optimize the flexibility of the cable. In this embodiment, the electrically conducting strands together form a bunch.

The electrically conducting strands (or respectively the electrically conducting wires making up a strand) are preferably compressed.

The elongated electrically conducting element (or respectively the electrically conducting strands) preferably have an electrical conductivity of at least 50% IACS, and especially preferably in the range from about 60 to 105% IACS.

In the invention, the electrical conductivity of a material, expressed in % IACS (IACS being an English-language acronym, for “International Annealed Copper Standard”), is determined relative to the electrical conductivity at 20° C. of annealed pure copper, which is 5.8001×10⁷ S/m. The electrical conductivity (S/m) characterizes the ability of a material to allow the electrons that it contains to move freely under the effect of an electric field and therefore allow the passage of an electric current. The electrical conductivity in % IACS is a conductivity determined with direct current.

The electrically conducting strands are preferably of copper.

The elongated electrically conducting element (or respectively the electrically conducting strands) is (are) preferably non-composite or non organic.

In the invention, the expression “non organic” relating to the strand or the element signifies that the strand or element does not comprise organic polymer or carbon; or that the strand or element is free from organic polymer or carbon.

In the invention, the expression “non-composite” relating to the strand or the element signifies that the strand or element does not comprise organic polymer and carbon; or that the strand or element is free from organic polymer and carbon. In other words, a non-composite strand or element is different from a carbon-containing strand or element in which carbon is mixed with (or impregnated with) at least one organic polymer.

In fact, the composite or organic strands as described in the prior art are non-conducting strands or strands having insufficient electrical conductivity. Moreover, impregnation of carbon-containing strands in an organic polymer matrix increases the rigidity of said carbon-containing strands, which limits the flexibility of the cable obtained.

According to a preferred embodiment, the conducting strands are not surrounded by a filler material for filling the holes between the strands. Consequently, the elongated electrically conducting element comprises free interstices between the conducting strands. The advantages of such an embodiment of the invention are lower weight and better flexibility of the cable.

### Fluorinated Polymer Layer

The fluorinated polymer layer may comprise at least one fluorinated polymer.

In the present invention, “polymer” means any type of polymer, such as for example homopolymers or copolymers (e.g. block copolymer, random copolymer, terpolymer, etc.).

Preferably, the fluorinated polymer is selected from all the polymers comprising tetrafluoroethylene as monomer, polytetrafluoroethylene (PTFE), poly(tetrafluoroethylene-co-hexafluoropropylene) (FEP), the copolymer perfluoro(alkylvinylether)/tetrafluoroethylene (PFA), poly(ethylene-co-tetrafluoroethylene) (ETFE), and a mixture thereof.

The fluorinated polymer layer preferably has a thickness from about 0.1 to 4 mm, and especially preferably from about 0.5 to 4 mm.

Preferably, the fluorinated polymer layer comprises, by weight relative to the weight of said layer, at least 50% of fluorinated polymer(s), preferably at least 70% of fluorinated polymer(s), and even more preferably at least 80% of fluorinated polymer(s), and even more preferably 90% of fluorinated polymer(s).

Advantageously, the fluorinated polymer is PFA. In fact, this polymer has good properties of dielectric strength and it has a suitable melting point that facilitates processing thereof by extrusion.

According to the invention, the fluorinated polymer layer may be taped and/or extruded.

When it is taped, the fluorinated polymer layer may correspond to the winding of one or more tapes of fluorinated polymer(s).

Preferably, the fluorinated polymer layer comprises one or more tapes of fluorinated polymer(s), and an extruded layer of fluorinated polymer(s) covering the tape or tapes of fluorinated polymer(s).

The fluorinated polymer layer may be a partially or fully sintered layer, preferably fully sintered. This allows it to be endowed with good mechanical properties.

Preferably, the fluorinated polymer layer is an electrically insulating layer. “Electrically insulating layer” means a layer generally having an electrical zo conductivity of at most 1.10⁻⁸ S/m (siemens per metre), preferably of at most 1.10⁻⁹ S/m, and especially preferably of at most 1.10⁻¹⁰ S/m, measured at 25° C. with direct current.

### The Metallic Layer Comprising Nickel

The metallic layer comprising nickel is interposed between the fluorinated polymer layer and the elongated electrically conducting element. In other words, the fluorinated polymer layer surrounds the metallic layer comprising nickel and the metallic layer comprising nickel surrounds the elongated electrically conducting element or the plurality of electrically conducting strands.

Owing to this metallic layer of nickel interposed between the fluorinated polymer layer and the elongated electrically conducting element, the cable has improved corrosion resistance, while guaranteeing a lower total weight and a lower cost of production.

According to a preferred embodiment of the invention, the metallic layer comprising nickel comprises at least about 50 wt % of nickel, especially preferably at least about 70 wt % of nickel, and more especially preferably at least about 90 wt % of nickel, relative to the total weight of the metallic layer comprising nickel.

The metallic layer comprising nickel may comprise at most about 100 wt % of nickel, and especially preferably at most about 95 wt % of nickel, relative to the total weight of the metallic layer comprising nickel.

According to an especially preferred embodiment of the invention, the layer of nickel comprises only nickel.

The metallic layer comprising nickel preferably has a thickness from about 10 μm to 2 mm, especially preferably from about 30 μm to 1.8 mm, more especially preferably from about 50 μm to 1.5 mm, and more especially preferably from about 0.1 mm to 1.0 mm. This thus makes it possible to guarantee a good compromise between good corrosion resistance and a lower total weight and a lower cost of production. In fact, when the thickness of this metallic layer is less than 10 μm, the elongated electrically conducting element is not sufficiently protected against corrosion and when the thickness of this metallic layer is greater than 2 mm, the cost price becomes too great without any corresponding improvement in the mechanical properties.

Moreover, it has been demonstrated, surprisingly, that the use of a metallic layer comprising nickel surrounding a plurality of electrically conducting strands makes it possible to reduce the skin effect, relative to a cable having a metallic layer comprising nickel on each of the electrically conducting strands. In particular, nickel has high magnetic permeability, inducing a non-negligible skin effect in the electrically conducting element when it is used as a coating of each of the electrically conducting strands. In the cable of the invention, the metallic layer of nickel surrounding the plurality of electrically conducting strands reduces the skin effect, thus allowing operation of the electric cable of the invention at high frequencies (e.g. 1200 Hz).

This also makes it possible to avoid long and complex application of nickel on each of the electrically conducting strands and reduce the cost price of the cable and/or the weight of the cable while guaranteeing corrosion resistance.

The metallic layer comprising nickel is preferably a solid or dense layer. In other words, it does not comprise interstices and/or it is formed from just a single element. Consequently, the metallic layer comprising nickel is preferably different from braiding or metal sheathing.

According to a preferred embodiment of the invention, the metallic layer comprising nickel is directly in physical contact with the elongated electrically conducting element. In other words, this signifies that no additional layer, of whatever nature, can be inserted between the elongated electrically conducting element and said metallic layer comprising nickel. In particular, the cable does not comprise an intermediate layer or layers, in particular metallic layer(s) or polymer layer(s), positioned between said elongated electrically conducting element and the metallic layer comprising nickel. The elongated electrically conducting element then has an outside surface in direct physical contact with the metallic layer comprising nickel.

In this embodiment, only a proportion of the electrically conducting strands of the outermost layer of the elongated electrically conducting element are preferably in direct physical contact with the metallic layer comprising nickel.

Owing to this metallic layer comprising nickel, oxidation of the elongated electrically conducting element of the invention, in particular associated with the zo presence of products resulting from decomposition of the polymer material of the fluorinated polymer layer, is avoided both at room temperature (i.e. 20° C.), and at high temperatures from 100° C. to 200° C. Moreover, the elongated electrically conducting element of the invention maintains good electrical properties, in particular in terms of electrical conductivity, resistivity and linear resistance, good mechanical properties, in particular in terms of performance in bending (good adherence of the coating on the elongated electrically conducting element, no separation after bending) and behaviour in elongation (no surface cracking after wiredrawing).

Advantageously, the metallic layer comprising nickel may be obtained by chemical deposition of nickel, by electrolytic deposition of nickel, or by application of tape comprising nickel.

Chemical deposition of nickel, also called “chemical nickel plating”, may be carried out by techniques familiar to a person skilled in the art after the optional pretreatments of the metallic surface of the elongated electrically conducting element of the invention to remove the residues of fats and oils (machining, manipulation), oxides (corrosion, heat treatment scale) and activate the surface.

Preferably, chemical deposition of the metallic layer comprising nickel is carried out by autocatalytic reduction of a nickel salt in an alkaline aqueous medium (i.e. pH>7), and preferably at a pH from about 9.5 to 11.5 or in an acidic aqueous medium (i.e. pH<7), and preferably at a pH from about 1 to 4.

The elongated electrically conducting element is thus for example immersed in an aqueous nickel plating bath comprising a nickel salt, which may for example be selected from nickel chloride, nickel sulphate, nickel sulphamate, or nickel hypophosphite, and at least one alkaline agent in a sufficient amount to bring the pH of the bath to the desired value. The nickel deposit is then obtained by autocatalytic reduction of the nickel ions in solution in contact with the metallic surface of the elongated electrically conducting element. When the alkaline agent is selected from phosphorus-containing compounds such as for example sodium hypophosphite, nickel and phosphorus are then co-deposited on said core, i.e. the nickel and the phosphorus are alloyed during deposition thereof on said elongated electrically conducting element. In this case, the medium contains the nickel salt and sodium hypophosphite in amounts corresponding to the percentage by weight of phosphorus that is to be obtained in the nickel alloy.

The concentration of nickel salt in the nickel plating bath is generally in the range from 1 to 10 g/L, and preferably from 4.9 to 6 g/L for an alkaline nickel plating bath and from 60 to 120 g/L, and preferably from 80 to 100 g/L for an acid nickel plating bath.

The electrolytic deposition of nickel may also be carried out by techniques familiar to a person skilled in the art, after immersion of the elongated electrically conducting element in an electrolysis bath comprising at least one nickel salt in solution.

The concentration of nickel salt (e.g. nickel sulphate or nickel chloride) in the electrolysis bath is generally in the range from 10 to 450 g/L, and preferably from 20 to 300 g/L.

In a preferred embodiment, the electrolytic parameters used in electrodeposition are defined by current density and conductivity of the electrolysis bath. The current density is preferably fixed from about 0.5 to 80 A/dm², and even more preferably from about 0.5 to 20 A/dm². The temperature of the electrolysis bath may be from 30° C. to 70° C.

Preferably, electrodeposition is carried out in an acid medium with a current density from about 0.5 to 80 A/dm², and even more preferably from about 0.5 to 20 A/dm².

Application of the tape comprising nickel may be done by winding tape around the elongated electrically conducting element or by taping.

Winding may be longitudinal (i.e. along the longitudinal axis of the cable or in other words in the direction of the length of the cable) or helicoidal, and preferably helicoidal.

Winding may moreover be carried out with overlapping zones, the overlapping zone or zones representing from about 5 to 40%, and preferably from about 10 to 20%.

According to one embodiment of the invention, the tape comprising nickel has a thickness from about 50 μm to 2 mm, and more especially preferably from about 0.1 mm to 1.5 mm.

According to one embodiment of the invention, the metallic layer comprising nickel obtained by chemical deposition of nickel or by electrolytic deposition of nickel has a thickness in the range from about 10 μm to 1.5 mm, and more especially preferably from about 50 mm to 1.0 mm.

### The Cable

The cable may further comprise a layer, in particular electrically insulating, comprising polyimide (PI) interposed between the metallic layer comprising nickel and the fluorinated polymer layer.

The cable may further comprise at least one fluorinated adhesive layer, which may comprise at least one fluorinated polymer as defined in the invention, the fluorinated polymer comprised in said fluorinated adhesive layer being in particular identical to or different from that comprised in the fluorinated polymer layer of the invention.

Advantageously, at least one fluorinated adhesive layer is arranged on at least one of the two faces of the layer comprising polyimide. An adhesive layer has the function of allowing adhesion between the layers that it bonds.

In fact, the fluorinated polymer or polymers of the adhesive layer receive a treatment beforehand that gives them their adhesive property.

According to one embodiment, the layer comprising a polyimide and the fluorinated polymer layer are separated by a fluorinated adhesive layer.

The layer comprising a polyimide may be covered on each of its faces with a fluorinated adhesive layer, and in particular with a coating of fluorinated ethylene/propylene copolymer (FEP).

The cable may further comprise at least one first fluorinated semiconducting layer, which may comprise at least one fluorinated polymer as defined in the invention, the fluorinated polymer comprised in said first semiconducting layer being in particular identical to or different from that comprised in the fluorinated polymer layer of the invention.

The first fluorinated semiconducting layer may for example be interposed between the metallic layer comprising nickel and the fluorinated polymer layer, and in particular may be in direct physical contact with the metallic layer comprising nickel.

The cable may further comprise at least one second fluorinated semiconducting layer, which may comprise at least one fluorinated polymer as defined in the invention, the fluorinated polymer comprised in said second semiconducting layer being in particular identical to or different from that comprised in the fluorinated polymer layer of the invention.

The second fluorinated semiconducting layer may for example surround the fluorinated polymer layer, and in particular may be in direct physical contact with the latter.

The semiconducting layer or layers may comprise at least one conductive filler, in particular in a sufficient amount to make the layer semiconducting.

The semiconducting layer or layers may comprise at least about 6 wt % of conductive filler, preferably at least about 15 wt % of conductive filler, and especially preferably at least about 25 wt % of conductive filler, relative to the total weight of the semiconducting layer or layers.

The semiconducting layer or layers may comprise at most about 45 wt % of conductive filler, and preferably at most about 40 wt % of conductive filler, relative to the total weight of the semiconducting layer or layers.

The conductive filler is preferably an electrically conducting filler.

The conductive filler may advantageously be selected from carbon blacks such as for example acetylene black or furnace black, graphites, and a mixture thereof.

In the present invention, “semiconducting layer” means a layer whose electrical conductivity may be strictly above 1.10⁻⁸ S/m (siemens per metre), preferably at least 1.10⁻³ S/m, and preferably may be less than 1.10³ S/m, measured at 25° C., with direct current.

In one embodiment, the electric cable further comprises a markable outer (surface) layer. This outer layer may be a tape or an extrudate of fluorinated polymer or a fluorinated varnish, comprising for example pigments of the metal complex type.

The cable comprising the aforementioned characteristics is intended to be used in the field of aeronautics and is in particular intended for equipping aircraft.

### Method

The second aim of the invention is a method of manufacturing an electric cable according to the first aim of the invention, characterized in that it comprises at least the following steps:

i) making said elongated electrically conducting element comprising a plurality of electrically conducting strands,

ii) depositing the metallic layer comprising nickel, and

iii) applying the fluorinated polymer layer.

Step i)

Step i) may comprise assembling the electrically conducting strands.

Step i) is advantageously carried out by stranding or bunching, and preferably by bunching.

Step ii)

Step ii) may be carried out by chemical deposition of nickel, by electrolytic deposition of nickel, or by application of tape comprising nickel, around the elongated electrically conducting element.

The chemical deposition of nickel, the electrolytic deposition of nickel, and the application of tape comprising nickel are as defined in the first aim of the invention.

Step iii)

Step iii) may be carried out by extrusion and/or taping.

Other features and advantages of the present invention will become clear from the examples given hereunder, referring to the annotated figures, said examples and figures being given for purposes of illustration, and not being in any way limiting.

### BRIEF DESCRIPTION OF THE DRAWINGS

The appended drawings illustrate the invention:

FIG. 1 shows a cross-sectional view of a cable according to one embodiment of the invention.

For clarity, only the elements essential for understanding the invention are shown schematically, without being to scale.

### DETAILED DESCRIPTION

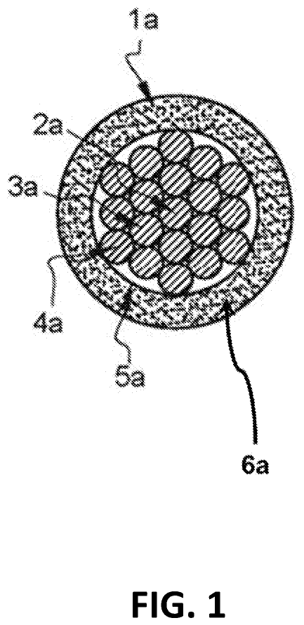

FIG. 1 shows a cross-sectional view of a cable 1 according to the invention.

In FIG. 1, the electric cable la comprises a central elongated electrically conducting element comprising a central electrically conducting strand 2a, a first layer comprising six electrically conducting strands 3a surrounding said central electrically conducting strand 2a, and a second layer comprising twelve electrically conducting strands 4a surrounding said first layer. The central elongated electrically conducting element is surrounded by a metallic layer comprising nickel 5a, and said metallic layer comprising nickel 5a is surrounded by a fluorinated polymer layer 6a.

1. An electric cable comprising:
at least one elongated electrically conducting element containing a plurality of electrically conducting strands, and
at least one fluorinated polymer layer surrounding said elongated electrically conducting element,
wherein said cable further comprises a metallic layer comprising nickel interposed between the elongated electrically conducting element and the fluorinated polymer layer, said metallic layer comprising nickel surrounding the plurality of electrically conducting strands.

2. The electric cable according to claim 1, wherein the metallic layer comprising nickel comprises at least 50 wt % of nickel relative to the total weight of the metallic layer comprising nickel.

3. The electric cable according to claim 1, wherein the metallic layer comprising nickel has a thickness from 10 μm to 2 mm.

4. The electric cable according to claim 1, wherein the metallic layer comprising nickel is directly in physical contact with the elongated electrically conducting element.

5. The electric cable according to claim 1, wherein the metallic layer comprising nickel is obtained by chemical deposition of nickel, by electrolytic deposition of nickel, or by application of tape comprising nickel.

6. The electric cable according to claim 1, wherein the fluorinated polymer layer comprises at least one fluorinated polymer.

7. The electric cable according to claim 1, wherein the fluorinated polymer layer comprises at least one fluorinated polymer selected from all the polymers comprising tetrafluoroethylene as monomer, polytetrafluoroethylene (PTFE), poly(tetrafluoroethylene-co-hexafluoropropylene) (FEP), the copolymer perfluoro(alkylvinylether)/tetrafluoroethylene (PFA), poly(ethylene-co-tetrafluoroethylene) (ETFE), and a mixture thereof.

8. The electric cable according to claim 1, wherein the fluorinated polymer layer is an electrically insulating layer.

9. The electric cable according to claim 1, wherein the elongated electrically conducting element comprises a central electrically conducting strand, at least one first layer of electrically conducting strands surrounding said central electrically conducting strand, and preferably at least one second layer of electrically conducting strands surrounding said first layer of electrically conducting strands.

10. The electric cable according to claim 1, wherein the metallic layer comprising nickel is a solid layer.

11. The electric cable according to claim 1, wherein the elongated electrically conducting element is non-composite or non organic.

12. The electric cable according to claim 1, wherein said electric cable further comprises at least one first fluorinated semiconducting layer, said first fluorinated semiconducting layer being interposed between the metallic layer comprising nickel and the fluorinated polymer layer.

13. A Method of manufacturing an electric cable as defined in claim 1, wherein said method comprises at least the following steps:
i) making said elongated electrically conducting element comprising a plurality of electrically conducting strands,
ii) depositing the metallic layer comprising nickel, and
iii) applying the fluorinated polymer layer.

14. The method of manufacturing an electric cable according to claim 13, characterized in that step ii) is carried out by chemical deposition of nickel, by electrolytic deposition of nickel, or by application of tape comprising nickel, around the elongated electrically conducting element.
